(19) United States
(12) Patent Application Publication
(10) Pub. No.: US 2006/0140451 A1
(43) Pub. Date: Jun. 29, 2006

(54) Motion detection method

(75) Inventors: Chia-Chu Cheng, Taipei (TW); Shih-Chang Cheng, Taipei (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/304,702

(22) Filed: Dec. 16, 2005

(30) Foreign Application Priority Data
Dec. 24, 2004 (TW) 93140676

(51) Int. Cl. G06K 9/00

(52) U.S. Cl. 382/107

(57) ABSTRACT

A motion detection method makes use of a reference sensor and a plurality of comparison sensors of a motion detection module to capture detection data. With the operation of a domain transformation and the use of discriminants (for direction, the number of times of movement, and speed), the number of sensors used can be decreased, and it is not necessary to use sensors with good uniformity. Moreover, conventional complicated algorithms can be simplified, and the influence on original detection data due to environment, electric noise and difference between sensors can be avoided, thereby precisely calculating out the motion direction and speed of the motion detection module.

### BACKGROUND OF THE INVENTION

1. Field of the Invention

The present invention relates to a motion detection method and, more particularly, to a motion detection method, which precisely calculates out the motion direction and speed of a motion detection module by using sensors of the motion detection module as well as the operation of a domain transformation and use of discriminants.

2. Description of Related Art

A common optical motion detector (e.g., a commercial optical mouse) uses an image sensor array to capture continuous array image information of a surface on the motion plane. The analog signals of sensor output are converted by an A/D converter to digital signals and then processed by a digital signal processor (DSP) to extract correlation information between continuous array images. The displacement information of said motion detector is then discriminated based on the extracted correlation information.

As to the DSP operation, image-matching of continuous arrays adopted by the above optical motion detector makes use of block-matching to determine the motion of the motion detector. As shown in FIG. 1, block-matching is accomplished by partitioning A/D converted image data into blocks of a size of n×n (the smallest block can be the unit of the sensor, i.e., with a size of 1×1) and comparing the image of each block on the present frame A1 with each block in a reference frame A2 or a related block specified by different algorithms to get a displacement M1 (the displacement of the present frame A1) in two dimensions. Because of various process factors in manufacturing, the problem of uniformity due to the difference of characteristics between sensor pixels usually arises. Besides, circuit noise, manufacturing error of related optical mechanisms, and production calibration error will cause slight errors in the continuous array image information generated by the sensor array, by which operation decisions are made. This kind of error will easily result in subsequent operation decision errors and also lead to errors in the decision of the motion direction and speed.

Manufacturers of common motion detectors usually use two methods to solve the above problem. In the first method, frames having these errors are passively discarded to keep the mouse cursor at the original position without any displacement. This will cause a jump phenomenon in the output of the motion detector. The second method still uses frames having these errors for comparison, but has no capability of accurately determining the motion direction. Therefore, the phenomenon of a jitter of the movement trace or motion error will easily occur.

In another method, the correlation between frame image information of several previous continuous frames is used to estimate or predict the oncoming motion. Compared with the motion information obtained by operating the actually detected continuous frame image information, the difference is somewhat corrected for use as the final motion decision information.

The above method, however, requires a sensor array with better uniformity and more complicated algorithms.

### SUMMARY OF THE INVENTION

An object of the present invention is to provide a motion detection method and device, which make use of a reference sensor and a plurality of comparison sensors of a motion detection module to capture detection data. With the operation of a domain transformation and the use of discriminants, the number of sensors used can be decreased, and conventional complicated algorithms can be simplified. Moreover, the influence on original detection data due to optical mechanism, production process, electric noise and difference between sensors can be greatly reduced, thus enhancing the anti-perturbation capability of the motion detection device.

A first aspect of the present invention provides a motion detection method, which comprises the steps of: providing a motion detection module having a reference sensor and a plurality of comparison sensors (the reference sensor is used to generate a reference pixel rp, the comparison sensors are used to generate a plurality of corresponding comparison pixels r1, r2, . . . , rN); performing repetitive data sensing function to get reference pixel data rp[k] from the reference sensor and comparison pixels data r1[k], r2[k], . . . , rN[k] of the comparison sensors according to a sampling timing sequence k=1, 2, 3, . . . ; respectively selecting a detection data segment with a length L from the detection data; performing a domain transformation to the detection data segment with a length L to get a reference domain data RP[K] and comparison domain data R1[K], R2[K], . . . , RN[K], K=1, 2, 3, . . . , L; getting an approximate comparison domain data Rx[K] nearest to the reference domain data RP[K] based on a direction discriminant, where x will be a integer number between 1 to N; and getting through inference an approximate comparison pixel rx whose action is nearest to the reference pixel rp according to the reference domain data RP[K] and the comparison domain data Rx[K] so as to obtain a motion direction of the motion detection module.

A second aspect of the present invention provides a motion detection method, which comprises the steps of: providing a motion detection module having a reference sensor and a plurality of comparison sensors (the reference sensor is used to generate a reference pixel rp, the comparison sensors are used to generate a plurality of corresponding comparison pixels r1, r2, . . . , rN); performing repetitive data sensing function to get reference pixel data rp[k] from the reference sensor and comparison detection data r1[k], r2[k], . . . , rN[k] of the comparison sensors according to a sampling timing sequence k=1, 2, 3, . . . ; respectively selecting a detection data segment with a length L from the detection data; performing a domain transformation to the detection data segment with a length L to get a reference domain data RP[K] and comparison domain data R1[K], R2[K], . . . , RN[K], K=1, 2, 3, . . . , L; getting an approximate comparison domain data Rx[K] nearest to the reference domain data RP[K] based on a direction discriminant, where will be a integer number between 1 to N; getting through inference an approximate comparison pixel rx whose action is nearest to the reference pixel rp according to the reference domain data RP[K] and the comparison domain data Rx[K] so as to obtain a motion direction of the motion detection module; substituting part of the reference pixel data rp[k] and the comparison detection data rx[k] into a discriminant of number of times of movement to get a number of times of movement making a speed discriminant minimal; and substituting the number of times of movement into the speed discriminant to get a motion speed of the motion detection module.

### BRIEF DESCRIPTION OF THE DRAWINGS

The various objects and advantages of the present invention will be more readily understood from the following detailed description when read in conjunction with the appended drawing, in which:

FIG. 1 is a diagram showing the conventional method of determining the motion direction of a motion detection module;

FIG. 2 is a flowchart of discriminating the motion direction of a motion detection method of the present invention;

FIG. 3 is a diagram showing the arrangement shape of sensors according to a first embodiment of the present invention;

FIG. 4 is a diagram showing the arrangement shape of sensors according to a second embodiment of the present invention; and

FIG. 5 is a flowchart of discriminating the motion direction and speed of a motion detection method of the present invention.

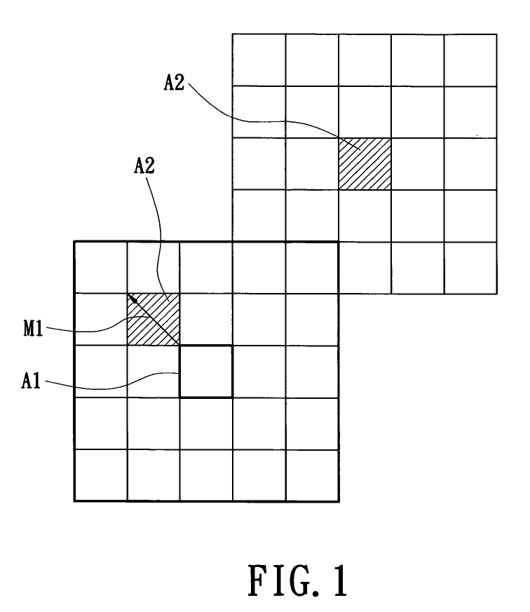

### DETAILED DESCRIPTION OF THE PREFERRED EMBODIMENTS

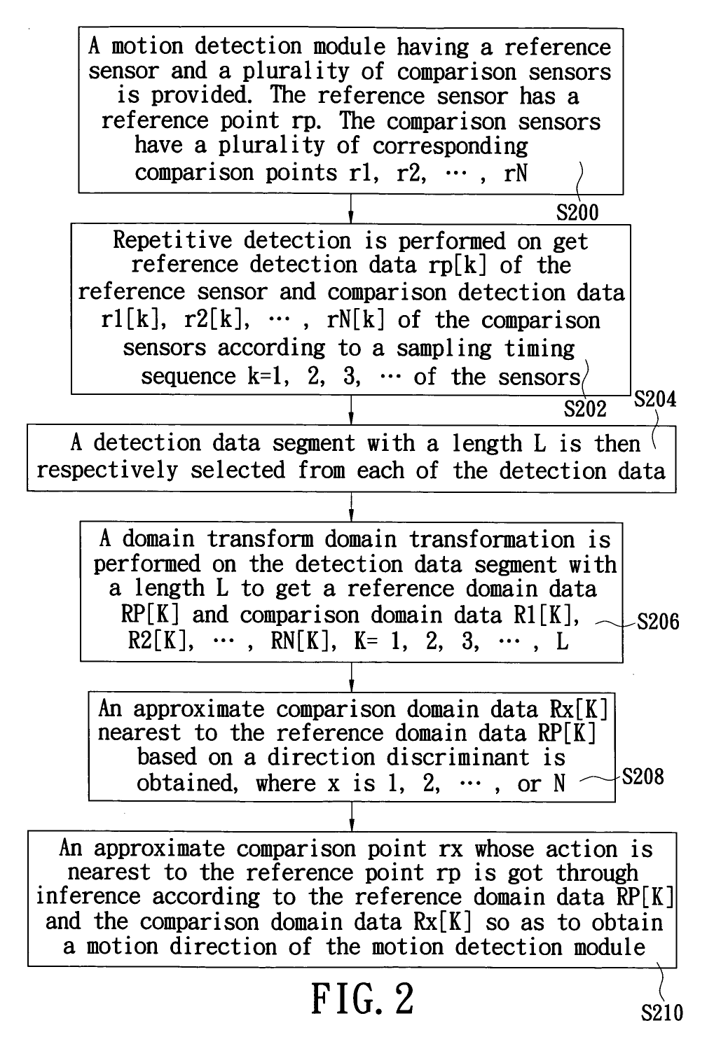

As shown in FIG. 2, the present invention provides a motion detection method, which comprises the following steps. First, a motion detection module 1 having a reference sensor 10 and a plurality of comparison sensors 11 is provided (Step S200). The reference sensor 10 is used to generate a reference pixel rp. The comparison sensors 11 are used to generate a plurality of corresponding comparison pixels r1, r2, . . . , rN.

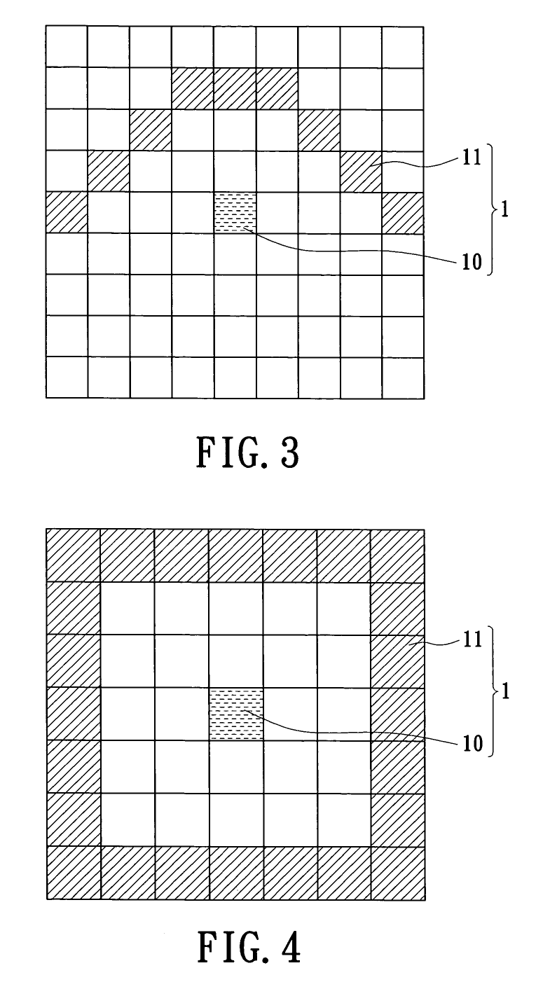

As long as the lines connecting the comparison sensors 11 and the central reference sensor 10 are not repetitive (if there is repetitive situation, the one with the shortest distance to the reference sensor 10 is given priority) and the arrangement shape of the comparison sensors 11 covers at least half a plane with the reference sensor 10 as the center, the comparison sensors 11 can be arranged in a rectangular shape (as shown in FIG. 3), a circular shape, a semi-circular shape, a U-shaped, a diamond shape, or a triangular shape (as shown in FIG. 4). The present invention, however, is not limited to the above arrangement ways. Besides, the motion detection module 1 can be used in optical scanners, optical pens, optical mice, or any optical motion detection devices.

Next, repetitive detection is performed on get reference pixel data rp[k] from the reference sensor and comparison detection data r1[k], r2[k], . . . , rN[k] of the comparison sensors according to a sampling timing sequence k=1, 2, 3, . . . (Step S202). A detection data segment with a length L is then respectively selected from each of the detection data (Step S204). Subsequently, a domain transformation is performed on the detection data segment with a length L to get a reference domain data RP[K] and comparison domain data R1[K], R2[K], . . . , RN[K], K=1, 2, 3, . . . , L (Step S206). The domain transformation can be a discrete Fourier transformation (DFT), a fast Fourier transformation (FFT), a discrete cosine transformation (DCT), a discrete Hartley transformation (DHT), or a discrete wavelet transformation (DWT). The present invention, however, is not limited to the above domain transformations. In other words, any domain transformation capable of transforming time domain to frequency domain or exhibiting signal variation characteristics can be used in the present invention.

Before performing the domain transformation, image data captured by each sensor will be different due to influences of optical mechanism, production process, electric noise and difference between sensors even if the space domain data of each sensor has the same traces. Moreover, because each error source is generated randomly, it is difficult to induce its characteristics, thus easily causing errors in subsequent motion decision.

On the other hand, if the traces of the sensors are identical to the trace of the original reference pixel, the data after domain transformation will still maintain a high similarity, even when subject to the influence of optical mechanism, production process, electric noise, and differences between sensors to result in different space domain data.

Next, an approximate comparison domain data Rx[K] nearest to the reference domain data RP[K] based on a direction discriminant is obtained, where x will be a integer number between 1 to N (Step S208). The direction discriminant is

$$Min \{ {\sum }_{K = 1}^{L} {\{ RP [ K ] - Rx [ K ] \}}^{2} \} or Min \{ {\sum }_{K = 1}^{L} \{ RP [ K ] - Rx [ K ] \} \} ,$$

where n=1, 2, . . . , N. An index n making the above discriminant the minimum criteria is thus found, and is specified as x.

Finally, an approximate comparison pixel rx whose action is nearest to the reference pixel rp is got through inference according to the reference domain data RP[K] and the comparison domain data Rx[K] so as to obtain a motion direction of the motion detection module (Step S210). The motion direction of the motion detection module is along a straight line connecting the reference pixel rp and the approximate comparison pixel rx and faces the approximate comparison pixel rx.

The above comparison way has the closest domain energy distribution. For example (the present invention, of course, is not limited to this example):

rp[k]: the captured data sequence of the reference sensor 10;

r1[k]: the captured data sequence of a first sensor of the comparison sensors 11;

r2[k]: the captured data sequence of a second sensor of the comparison sensors 11;

. . . ;

rN[k]: the captured data sequence of an N-th sensor of the comparison sensors 11;

where k is an index of the timing sequence, and N is the number of the comparison sensors 11.

Next, a data sequence segment of length L is selected from each of the above data sequences, i.e.:

rp[d+1], rp[d+2], . . . , rp[d+L];

r1[d+1], r1[d+2], . . . , r1[d+L];

. . . ;

rN[d+1], rN[d+2], . . . , rN[d+L];

where d is an arbitrary number, i.e., a reference time for motion detection at a certain instant. In other words, d can be arbitrarily selected from the timing index, and d will be added by a pre-defined number after motion detection calculation.

Subsequently, domain transforms are performed on the above data sequences to get the following transform data:

RP[1], RP[2], . . . , RP[L];

R1[1], R1[2], . . . , R1[L];

RN[1], RN[2], . . . , RN[L];

A comparison pixel nearest to the movement trace of the reference pixel is obtained according to the following formula:

$$Min \{ {\sum }_{K = 1}^{L} {\{ RP [ K ] - Rx [ K ] \}}^{2} \} or Min \{ {\sum }_{K = 1}^{L} \{ RP [ K ] - Rx [ K ] \} \} ,$$

where n=1, 2, . . . , N. An index n most coinciding the reference pixel is thus found, and is specified as x. The line connecting from rp to rx is the motion direction of the motion detection module.

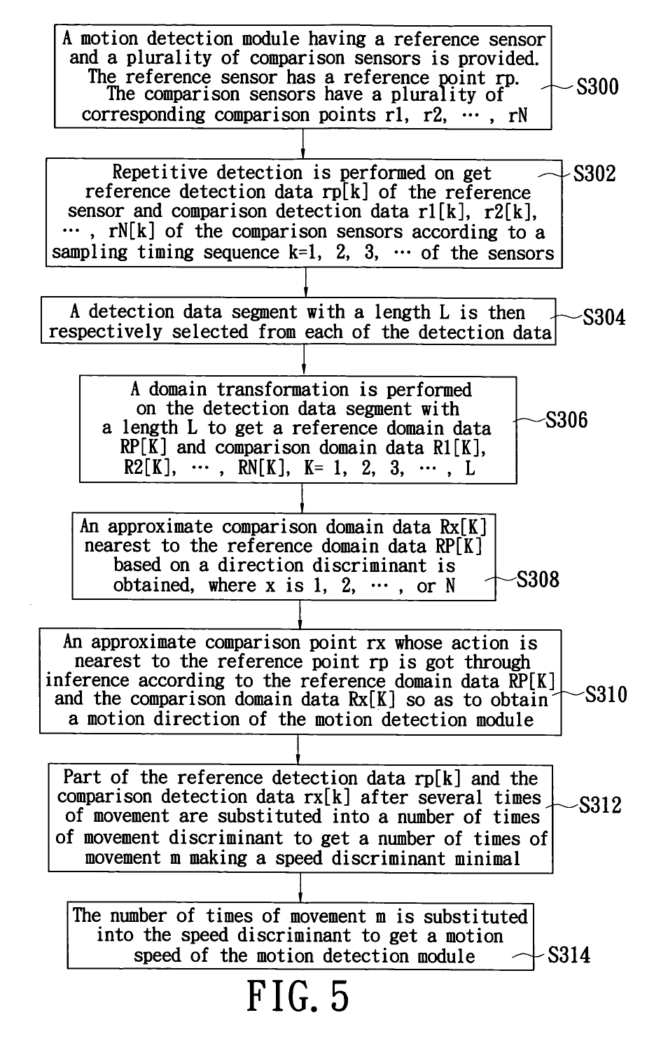

As shown in FIG. 5, Steps S300 to S310 are the same as Steps S200 to S210 described above with the object of obtaining the motion direction of the motion detection module 1.

Next, part of the reference pixel data rp[k] and the comparison detection data rx[k] after several times of movement are substituted into a number of times of movement discriminant to get a number of times of movement m making a speed discriminant minimal (Step S312). The speed discriminant is:

$$Min \{ {\sum }_{K = 1}^{D} {\{ rp [ s + k ] - rx [ k + m ] \}}^{2} \} ,$$

where D is a constant chosen according to data characteristics, and it is preferred that L/4<D<L/2; s is a constant chosen according to data characteristics, and it is preferred that s<L/4; and m is an unknown, and it is preferred that 0<m<L−D+1. The above suggested values, however, do not mean to limit use of the proposed discriminants of the present invention.

Finally, the number of times of movement m is substituted into the speed discriminant to get a motion speed of the motion detection module 1 (Step S314). The speed discriminant is V=Distance/(m×Δt), where Distance is the distance between the reference pixel rp and the approximate comparison pixel rx, and Δt is a time period between two successive sampling actions.

To sum up, the motion detection method of the present invention makes use of a reference sensor 10 and a plurality of comparison sensors 11 of a motion detection module 1 to select detection data. With the operation of a domain transformation and the use of discriminants (for direction, number of times of movement, and speed), the number of sensors used can be decreased, and conventional complicated algorithms can be simplified. Moreover, the influence to original detection data due to environment, electric noise and difference between sensors can be greatly reduced, thus precisely obtaining the motion direction and speed of the motion detection module 1.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A motion detection method, comprising the steps of:
providing a motion detection module having a reference sensor and a plurality of comparison sensors, said reference sensor for generating a reference pixel rp, and said comparison sensors for generating a plurality of corresponding comparison pixels r1, r2, . . . , rN;
performing repetitive data sensing function to get reference pixel data rp[k] of said reference sensor and comparison detection data r1[k], r2[k], . . . , rN[k] of said comparison sensors according to a sampling timing sequence k=1, 2, 3, . . . ;
respectively selecting a detection data segment with a length L from said detection data;
performing a domain transformation to said detection data segment with a length L to get reference domain data RP[K] and comparison domain data R1[K], R2[K], RN[K], K=1, 2, 3, . . . L;
getting approximate comparison domain data Rx[K] nearest to said reference domain data RP[K] based on a direction discriminant, where x will be a integer number between 1 to N; and
getting through inference an approximate comparison pixel rx, wherein an action of pixel rx is nearest to said reference pixel rp according to said reference domain data RP[K] and said comparison domain data Rx[K] so as to obtain a motion direction of said motion detection module.

2. The motion detection method as claimed in claim 1, wherein said comparison sensors are arranged in a rectangular shape, a circular shape, a semi-circular shape, a U-shaped, a diamond shape, or a triangular shape.

3. The motion detection method as claimed in claim 1, wherein the arrangement shape of said comparison sensors covers at least half a plane with said reference sensor as a center.

4. The motion detection method as claimed in claim 1, wherein said direction discriminant is
$$Min \{ {\sum }_{K = 1}^{L} {\{ RP [ K ] - Rx [ K ] \}}^{2} \} .$$

5. The motion detection method as claimed in claim 1, wherein said direction discriminant is
$$Min \{ {\sum }_{K = 1}^{L} \{ RP [ K ] - Rx [ K ] \} \} .$$

6. The motion detection method as claimed in claim 1, wherein the motion direction of said motion detection module is along a straight line connecting said reference pixel rp and said approximate comparison pixel rx, and faces said approximate comparison pixel rx.

7. The motion detection method as claimed in claim 1, wherein said domain transformation is a discrete Fourier transformation, a fast Fourier transformation, a discrete cosine transformation, a discrete Hartley transformation, or a discrete wavelet transformation.

8. A motion detection method, comprising the steps of:
providing a motion detection module having a reference sensor and a plurality of comparison sensors, said reference sensor for generating a reference pixel rp, said comparison sensors for generating a plurality of corresponding comparison pixels r1, r2, . . . , rN;
performing repetitive data sensing function to get reference pixel data rp[k] of said reference sensor and comparison detection data r1[k], r2[k], . . . , rN[k] of said comparison sensors according to a sampling timing sequence k=1, 2, 3, . . . ;
respectively selecting a detection data segment with a length L from said detection data;
performing a domain transformation on said detection data segment with a length L to get reference domain data RP[K] and comparison domain data R1[K], R2[K], . . . , RN[K], K=1, 2, 3, . . . , L;
getting approximate comparison domain data Rx[K] nearest to said reference domain data RP[K] based on a direction discriminant, where x will be an integer number between 1 to N;
getting through inference an approximate comparison pixel rx, wherein an action of pixel rx is nearest to said reference pixel rp according to said reference domain data RP[K] and said comparison domain data Rx[K] so as to obtain a motion direction of said motion detection module;
substituting part of said reference pixel data rp[k] and said comparison detection data rx[k] into a discriminant of number of times of movement to get a number of times of movement making a speed discriminant minimal; and
substituting said number of times of movement into said speed discriminant to get a motion speed of said motion detection module.

9. The motion detection method as claimed in claim 8, wherein said comparison sensors are arranged in a rectangular shape, a circular shape, a semi-circular shape, a U-shaped, a diamond shape, or a triangular shape.

10. The motion detection method as claimed in claim 8, wherein the arrangement shape of said comparison sensors covers at least half a plane with said reference sensor as the center.

11. The motion detection method as claimed in claim 8, wherein said direction discriminant is
$$Min \{ {\sum }_{K = 1}^{L} {\{ RP [ K ] - Rx [ K ] \}}^{2} \} .$$

12. The motion detection method as claimed in claim 8, wherein said direction discriminant is
$$Min \{ {\sum }_{K = 1}^{L} \{ RP [ K ] - Rx [ K ] \} \} .$$

13. The motion detection method as claimed in claim 8, wherein the motion direction of said motion detection module is along a straight line connecting said reference pixel rp and said approximate comparison pixel rx and faces toward said approximate comparison pixel rx.

14. The motion detection method as claimed in claim 8, wherein said domain transformation is a discrete Fourier transformation, a fast Fourier transformation, a discrete cosine transformation, a discrete Hartley transformation, or a discrete wavelet transform.

15. The motion detection method as claimed in claim 8, wherein said discriminant of number of times of movement is
$$Min \{ {\sum }_{K = 1}^{D} {\{ rp [ s + k ] - rx [ k + m ] \}}^{2} \} ,$$
where D and s are constants chosen based on the characteristic of data, and m is an unknown.

16. The motion detection method as claimed in claim 15, wherein preferable conditions include L/4<D<L/2, s<L/4, and 0<m<L−D+1.

17. The motion detection method as claimed in claim 8, wherein said speed discriminant is V=Distance/(m×Δt), where Distance is a distance between said reference pixel rp and said approximate comparison pixel rx, and Δt is a time period between two successive sampling actions.
